(19) United States
(12) Patent Application Publication
(10) Pub. No.: US 2026/0171412 A1
(43) Pub. Date: Jun. 18, 2026

(54) ANODE MATERIAL, PREPARATION METHOD THEREOF AND LITHIUM-ION BATTERY

(71) Applicant: BTR NEW MATERIAL GROUP CO., LTD., Guangdong (CN)

(72) Inventors: XINGYANG LIU, Guangdong (CN); HAIHUI ZHOU, Guangdong (CN); PENG HE, Guangdong (CN); JIANGUO REN, Guangdong (CN); YOUYUAN HUANG, Guangdong (CN); XUEQIN HE, Guangdong (CN)

(21) Appl. No.: 19/378,670

(22) Filed: Nov. 4, 2025

(30) Foreign Application Priority Data
Dec. 16, 2024 (CN) 202411850189.3

(51) Int. Cl. H01M 4/587; C01B 32/21; H01M 10/0525

(52) U.S. Cl. CPC H01M 4/587; C01B 32/21; H01M 10/0525; C01P 2002/72; C01P 2002/74; C01P 2004/32; C01P 2004/61; C01P 2006/11; C01P 2006/12; C01P 2006/14; C01P 2006/40

(57) ABSTRACT

An anode material comprising: a carbon material having pores therein, wherein a total pore volume of pores with a pore size of 3 nm or more and 1,000 nm or less, measured by mercury intrusion porosimetry is V1, and 0<V1<0.1 mL/g; a total pore volume of pores with a pore size of 3 nm or more and 400 nm or less, measured by mercury intrusion porosimetry is V2, and a ratio V2/V1 ranges from 40% to 70%; and a total pore volume of pores with a pore size of 3 nm or more and 500 nm or less, measured by mercury intrusion porosimetry is V3, and a ratio V3/V1≥60%.

### CROSS-REFERENCE TO RELATED APPLICATION AND CLAIM OF PRIORITY

This application claims the benefit under 35 USC § 119 of Chinese Patent Application No. 202411850189.3 filed on Dec. 16, 2024 in the China Intellectual Property Office, the entire disclosure of which is incorporated herein by reference for all purposes.

### BACKGROUND

### 1. Technical Field

The present application relates to the technical field of anode materials for lithium-ion batteries. More specifically, the present application relates to an anode material, a preparation method thereof and a lithium-ion battery.

### 2. Background of the Invention

Graphite is a mainstream anode material for lithium-ion batteries in the current market and may be classified into artificial graphite and natural graphite depending on different sources. The artificial graphite occupies most of the power battery market due to its excellent cycle stability, while the natural graphite has the advantages of high capacity, low carbon emission, but short cycle life. Currently, the natural graphite is usually modified in a surface coating method, where a layer of amorphous carbon is coated on a surface of the natural graphite to separate electrolyte from the natural graphite in a battery, thereby improving the performance of the natural graphite. This method is simple to operate, low in cost and widely applicable to modification of natural graphite anode materials. However, since the coating agent cannot completely cover the outer surface of the natural graphite (especially a flake graphite surface inside spherical graphite), the electrolyte may gradually permeate into the uncoated surface of the natural graphite in the cycle process, causing continuous generation of a solid electrolyte interface (SEI) and continuous intercalation of the electrolyte into the natural graphite layer structure, which may consume a large amount of active lithium, damage the natural graphite structure, and cause continuous capacity attenuation. In view of this, it is necessary to develop a new modification method for natural graphite which can enable densification or isotropization and pore size regulation on natural graphite particles, so that the pores as well as particle orientations of the natural spherical graphite particles can be reduced, thereby further reducing the expansion rate and improving the cycle performance of the material.

On this basis, there is a need for an anode material and a preparation method thereof which can improve the cycle life and fast charge performance, as well as the orientation and expansion rate of the prepared battery.

### SUMMARY

To address at least one or more of the above technical problems, the present application proposes, in various aspects, an anode material, a preparation method thereof and a lithium-ion battery.

According to one aspect of the present application there is provided an anode material comprising: a carbon material having pores therein; wherein a total pore volume of pores with a pore size of 3 nm or more and 1,000 nm or less, measured by mercury intrusion porosimetry is V1, and 0<V1<0.1 mL/g; a total pore volume of pores with a pore size of 3 nm or more and 400 nm or less, measured by mercury intrusion porosimetry is V2, and a ratio V2/V1 ranges from 40% to 70%; and a total pore volume of pores with a pore size of 3 nm or more and 500 nm or less, measured by mercury intrusion porosimetry is V3, and a ratio V3/V1≥60%.

According to another aspect of the present application, there is provided a preparation method for an anode material, including: a first step of selecting a carbonaceous material feedstock, and pulverizing and spheroidizing the carbonaceous material feedstock; a second step of performing pore regulation treatment on the carbon material obtained in the first step; and a third step of subjecting the carbon material obtained in the second step to high-temperature heat treatment. The pore regulation treatment includes any one or combination of at least two of modifier addition, fusion heating, reaction kettle heating, rolling, cold isostatic pressing treatment, hot isostatic pressing treatment or mold pressing treatment.

According to another aspect of the present application, there is provided a lithium-ion battery, including the anode material of any one of the foregoing embodiments, or an anode material prepared in the preparation method of any one of the foregoing embodiments.

According to the technical solutions provided in the examples of the present application, the pore volume of the anode material is reduced while the pore size distribution of the residual pores is adjusted, so that a low pore volume of the anode material is kept to extend the cycle life of the anode material and reduce the expansion rate, while some of the mesopores are reserved to ensure rapid transport of lithium ions in the material. By regulating the pore volume and pore volume distribution of the anode material, the technical solutions provided in the examples of the present application reduce orientation of the anode material, effectively reduce expansion of the anode material in the cycle process and extend the long cycle life of battery, while enabling a lower impedance of the anode material and effectively improving the fast charge performance of the anode material.

### BRIEF DESCRIPTION OF THE DRAWINGS

The above and other objectives, features and advantages of exemplary embodiments of the present application will become readily apparent from the following detailed description, which proceeds with reference to the accompanying drawings. In the accompanying drawings, several embodiments of the present application are illustrated by way of example but not limitation, and like or corresponding reference numerals indicate like or corresponding parts, in which:

FIG. 1 is a schematic diagram of a battery in a discharge state; and

FIG. 2 is a diagram showing pore volume distributions of carbon materials in example 1 and comparative example 1 of the present application.

### DETAIL DESCRIPTION OF THE INVENTION

The technical solutions in the examples of the present application will be clearly and completely described below with reference to the accompanying drawings in the examples of the present application. Apparently, the described examples are only part, but not all, of the examples of the present application. All other examples obtained by those skilled in the art based on the examples in the present application without any creative labor belong to the protection scope of the present application.

It will be understood that the terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular examples only and is not intended to limit the present application. As used in the specification and claims of the present application, the singular forms “a”, “an” and “the” are intended to include the plural forms as well, unless the context clearly indicates otherwise. It should be further understood that the term “and/or” as used in the description and claims of the present application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

Specific embodiments of the present application will be described in detail below with reference to the accompanying drawings, and materials, reagents and equipment used in the examples of the present application are all conventionally available from commercial sources, unless otherwise specified.

One embodiment of the present application provides a secondary battery (e.g., a lithium-ion battery, a sodium ion battery, or the like) including a housing, an electrode assembly, and an electrolyte solution/electrolyte. The electrode assembly and the electrolyte solution/electrolyte are both located within the housing.

The housing may be a package obtained by encapsulation with an encapsulation film (e.g., an aluminum-plastic film), and for example, the secondary battery is a pouch battery. In other examples, the secondary battery may be a steel-cased battery, an aluminum-cased battery, or the like.

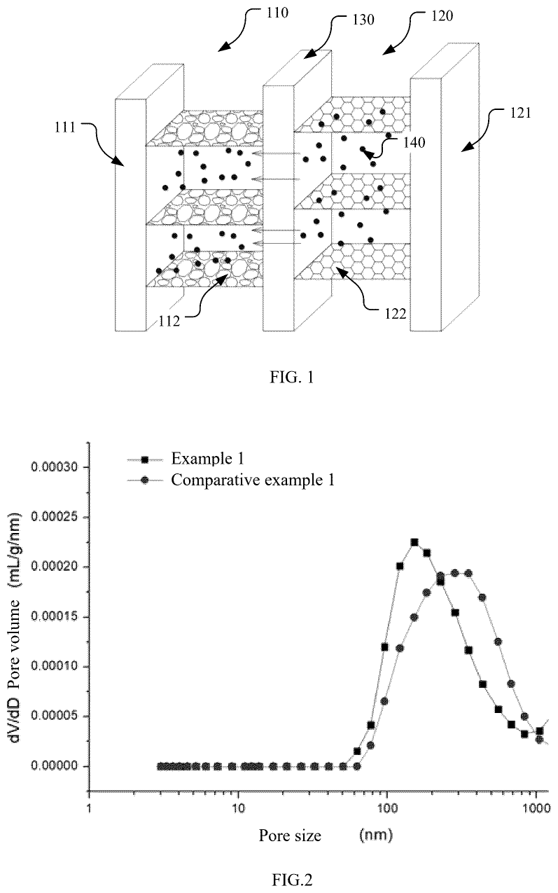

FIG. 1 is a schematic diagram of a battery in a discharge state, i.e., in operation. As shown, the electrode assembly includes a cathode sheet 110, an anode sheet 120, and an isolation film 130 disposed between the cathode sheet and the anode sheet. The electrode assembly may have a stacked structure formed by the cathode sheet, the isolation film, and the anode sheet sequentially stacked. In other examples, the electrode assembly may have a coiled structure formed by the cathode sheet, the isolation film, and the anode sheet sequentially stacked and coiled.

### Cathode Sheet

The cathode sheet 110 includes a cathode current collector 111 and a cathode active layer 112 on at least one surface of the cathode current collector. The cathode current collector may use an aluminum foil or a nickel foil or the like, or may be any composite current collector disclosed in the existing art, for example, but not limited to, a current collector formed by combining the conductive foil described above and a polymer substrate. The cathode active layer includes a cathode active material including a compound that enables reversible intercalation and deintercalation of metal icons. In some examples, the cathode active material may include a lithium transition metal composite oxide, a sodium transition metal composite oxide, or the like. The lithium transition metal composite oxide contains lithium and at least one element selected from cobalt, manganese, or nickel. In some examples, the cathode active material may include, but is not limited to, at least one of LiCoO₂, NCM, LiMn₂O₄, LiNi_{0.5}Mn_{1.5}O₄, or LiFePO₄.

### Anode Sheet

The anode sheet 120 includes an anode current collector 121 and an anode active material layer 122 on at least one surface of the anode current collector. The anode current collector may use at least one of a copper foil, a nickel foil, a stainless steel foil, a titanium foil, or a carbon-based current collector, or the like, or may be any composite current collector disclosed in the existing art, for example, but not limited to, a current collector formed by combining the conductive foil described above and a polymer substrate. The anode active material layer includes an anode material.

During operation of the battery, i.e., when the battery is in a discharge state, metal ions 140 (e.g., lithium ions) in the anode are deintercalated from lattices of the anode material, and pass through the isolation film 130 via the electrolyte solution/electrolyte, to be intercalated into lattices of the cathode material.

Conversely, when the battery is charged by applying an external circuit, oxidation of the cathode material causes metal ions (e.g., lithium ions) in the cathode to be deintercalated from lattices of the cathode material, pass through the isolation film via the electrolyte solution/electrolyte, and move to the anode; meanwhile, the anode material is subjected to reduction reaction so that metal ions are intercalated into lattices of the anode material.

As the metal ions reciprocate between the cathode and the anode, discharge and charge processes of the battery may be implemented in thousands of cycles.

The present application provides an anode material comprising: a carbon material having pores therein, wherein a total pore volume of pores with a pore size of 3 nm or more and 1,000 nm or less, measured by mercury intrusion porosimetry is V1, and 0<V1<0.1 mL/g; a total pore volume of pores with a pore size of 3 nm or more and 400 nm or less, measured by mercury intrusion porosimetry is V2, and a ratio V2/V1 ranges from 40% to 70%; and a total pore volume of pores with a pore size of 3 nm or more and 500 nm or less, measured by mercury intrusion porosimetry is V3, and a ratio V3/V1≥60%.

Illustratively, the ratio V2/V1 is 40%, 41%, 43%, 45%, 47%, 49%, 50%, 51%, 53%, 55%, 57%, 59%, 60%, 61%, 63%, 65%, 67%, 69%, or 70%; or within a range limited by any two of the above values; or in the range of 40% to 60%, or in the range of 50% to 70%, or in the range of 45% to 65%, or in the range of 50% to 60%, or in the range of 60% to 70%.

Illustratively, the ratio V3/V1 is 60%, 61%, 63%, 65%, 67%, 69%, 70%, 71%, 73%, 75%, 77%, 79%, or 80%; or within a range limited by any two of the above values; or in the range of 60% to 70%, or in the range of 65% to 70%, or in the range of 65% to 80%, or in the range of 70% to 80%.

Due to curled and stacked scales, many pores are formed in spherical graphite particles in a spheroidization process of the existing natural graphite anode material, resulting in relatively high pore volume and specific surface area of the material, as well as many surface defects. The technical solution of the present application reduces the pore volume of the material while controlling pore size distribution of residual pores, which helps to not only keep a low pore volume of the material, extend the cycle life of the material and reduce the cycle expansion, but also reserve some of the mesopores to ensure rapid transport of lithium ions in the material. The technical solution of the present application reduces the orientation of the material by regulating the pore volume and pore volume distribution of the material. A lower pore volume and a specific pore volume distribution can effectively reduce the expansion of the anode material in the cycle process and extend the long cycle life of battery, while enabling a lower impedance of the material and effectively improving the fast charge performance of the anode material. When the pore volume and pore volume distribution are out of target ranges, contact and consumption of the material and the electrolyte solution may be increased so that a relatively thick SEI film is formed and the electrolyte solution is reduced, resulting in a significantly reduced cycle life of the material and an increased expansion rate of the electrode sheet, while a larger pore size may cause reduced mechanical stability of the electrode material, thereby affecting the cycle life and safety of the battery.

Specifically, when V1≥0.1 mL/g, the contact between the carbon material and the electrolyte solution increases and more electrolyte solution is consumed, resulting in a smaller amount of electrolyte solution and a thicker SEI film, and therefore a significantly reduced cycle life of the material and an increased expansion rate of the electrode sheet. When V2/V1<40% or V3/V1<60%, pores in the material have pore sizes excessively concentrated in the range of 500 nm to 1,000 nm, and the too large pore sizes may cause reduced mechanical stability of the electrode material while increasing the contact and consumption of the electrolyte solution, thereby affecting the cycle life and safety of the battery. When V2/V1>70%, pores in the material have pore sizes excessively concentrated in the range of 3 nm to 400 nm, and the too small pore sizes are not beneficial to rapid transport of lithium ions and cause high impedance of the material, which may accelerate temperature rise of the battery as well as decomposition and consumption of the electrolyte solution, resulting in a higher expansion rate of the electrode sheet in the material, and a reduced cycle retention of the battery.

In some examples, in an XRD spectrum of the anode material (where XRD is abbreviation of “X-ray diffraction”: X-ray diffraction is an optical analysis method for detection by an instrument, in which monochromatic X-rays are irradiated onto a powder crystal sample, and if a set of plane orientations of one of the crystal grains has an angle θ to the incident X-rays, the diffraction condition is satisfied, and diffraction is generated at a diffraction angle 2θ), an 004 peak is present at 2θ of 54° to 55°, with an intensity I₀₀₄; a 110 peak is present at 2θ of 77° to 78°, with an intensity I₁₁₀; and a ratio of the two intensities I₀₀₄/I₁₁₀≤3.0. Illustratively, I₀₀₄/I₁₁₀ may be 2.9, 2.8, 2.7, 2.6, 2.5, 2.4, 2.3, 2.2, 2.1, 2.0, 1.8, 1.6, 1.4, 1.2, or any value within a range limited by any of the above values; or in the range of 1.0 to 3.0, or in the range of 1.5 to 3.0, or in the range of 2.0 to 3.0, or in the range of 2.5 to 3.0. According to the technical solution of the present application, pore size distribution of the pores is regulated to reduce orientation of the material, which can facilitate rapid transport of lithium ions and effectively improve the fast charge performance of the material. When the ratio I₀₀₄/I₁₁₀>3, the orientation of the material is enhanced, which is not beneficial to rapid transport of lithium ions and causes high impedance of the material, and may accelerate temperature rise of the battery as well as decomposition and consumption of the electrolyte solution, causing an increased expansion rate of the material and affecting the cycle life of the battery.

In some examples, the anode material has a Brunauer-Emmett-Teller (BET) specific surface area ≤3.0 m²/g, which may be, illustratively, 3.0 m²/g, 2.9 m²/g, 2.8 m²/g, 2.7 m²/g, 2.6 m²/g, 2.5 m²/g, 2.4 m²/g, 2.3 m²/g, 2.0 m²/g, 1.5 m²/g, 1.0 m²/g, 0.5 m²/g, or any value within a range limited by any of the above values. When the BET specific surface area falls in the above range, the lower specific surface area is beneficial to enable a higher initial coulombic efficiency of the material, so that the battery prepared from the anode material has an extended cycle life and better high-temperature storage performance.

In some examples, a volume median particle size Dv50 of the anode material is in a range of 5 μm to 25 μm, which may be, illustratively, 5 μm, 6 μm, 8 μm, 10 μm, 12 μm, 14 μm, 16 μm, 18 μm, 20 μm, 22 μm, 24 μm, 25 μm, or any value within a range limited by any of the above values. If an average particle size of the anode material is less than 5 μm, it is not beneficial to rapid transport of lithium ions in the anode material and may cause increased high impedance of the material and reduced cycle retention of the battery. If an average particle size of the anode material is greater than 25 μm, the too large particle size of the anode material may result in a larger space between particles of the anode material, which may affect the mechanical properties of the material and affect the cycle life of the battery. When Dv50 falls in the above range, it is beneficial to enable a higher initial coulombic efficiency of the material, so that the battery prepared from the anode material has an extended cycle life and better high-temperature storage performance.

In some examples, the anode material has a compaction density in a range of 1.5 g/cc to 2.1 g/cc, which may be, illustratively, 1.50 g/cc, 1.55 g/cc, 1.60 g/cc, 1.65 g/cc, 1.70 g/cc, 1.75 g/cc, 1.80 g/cc, 1.85 g/cc, 1.90 g/cc, 1.95 g/cc, 2.0 g/cc, 2.05 g/cc, 2.10 g/cc, or any value within a range limited by any of the above values. When the compaction density falls in the above range, the material has a higher compaction density so that the energy density of the battery prepared from the anode material is improved.

In some examples, the anode material has a tap density in a range of 0.9 g/cc to 1.2 g/cc, which may be, illustratively, 0.90 g/cc, 0.92 g/cc, 0.95 g/cc, 0.98 g/cc, 1.0 g/cc, 1.02 g/cc, 1.05 g/cc, 1.08 g/cc, 1.10 g/cc, 1.12 g/cc, 1.15 g/cc, 1.18 g/cc, 1.20 g/cc, or any value within a range limited by any of the above values. When the tap density falls in the above range, the material has a higher tap density so that in the preparation of an anode slurry, the slurry prepared from the anode material is more stable and consistent.

In some examples, the anode material has a fixed carbon content ≥99.94%, which may be, illustratively, 99.94%, 99.95%, 99.96%, 99.97%, 99.98%, 99.99%, or any value within a range limited by any of the above values. When the fixed carbon content falls in the above range, the higher fixed carbon content allows a higher capacity of the anode material, as well as better high-temperature storage performance of the prepared battery.

In some examples, the anode sheet made of the anode material has an expansion rate <27% after 20 cycles, which may be, illustratively, 26.5%, 26%, 25.5%, 25%, 24.5%, 24%, 23.5%, 23%, 22.5%, 22%, 21%, 20%, or any value within a range limited by any of the above values. The electrode sheet expansion rate after 20 cycles reflects expansibility of the material in use, and by regulating the pore volume and pore distribution, the present application allows significantly reduced expansibility of the anode sheet made of the anode material of the present application.

In some examples, the pouch battery made of the anode material has a capacity retention >85% after 300 cycles at 1C/1C, which may be, illustratively, 86%, 87%, 88%, 89%, 90%, 91%, 92%, 93%, or any value within a range limited by any of the above values. The capacity retention after 300 cycles at 1C/1C reflects cycle performance of the material in use, and by regulating the pore volume and pore distribution, the present application allows a significantly improved capacity retention of the battery made of the material.

In some examples, the carbon material includes natural graphite. By regulating the pore volume and pore distribution, the present application allows a reduced porosity, densification and isotropization of the natural graphite, while reserving a certain amount of mesopores, thereby reducing the expansion rate and improving the cycle performance of the material.

FIG. 2 is a diagram showing pore volume distributions of carbon materials in example 1 and comparative example 1 of the present application.

The present application further provides a preparation method for an anode material, which includes the following first to third steps S1 to S3. In the first step S1, a carbonaceous material feedstock is selected and subjected to pulverizing and spheroidizing. In a second step S2, pore regulation treatment is performed on the carbon material obtained in the first step. In a third step S3, the carbon material obtained in the second step is subjected to high-temperature heat treatment. The pore regulation treatment includes any one or combination of at least two of modifier addition, fusion heating, reaction kettle heating, rolling, cold isostatic pressing treatment, hot isostatic pressing treatment or mold pressing treatment.

According to the technical solution of the present application, the pore volume of the material and the pore size distribution of pores are precisely regulated through the steps of pore regulation treatment and the like, which, on one hand, keeps a low pore volume of the material while extending the cycle life and reducing the expansion rate of the material, and, on the other hand, reserves some mesopores to ensure rapid transport of lithium ions in the material, so that the material has lower impedance and the fast charge performance of the material is effectively improved.

In some examples, in the first step, the selected carbonaceous material feedstock may be highly crystalline graphite; and may be selected from the group consisting of one or more of natural spherical graphite, natural flake graphite, or microcrystalline graphite.

In some examples, in the first step, the pulverizing is performed by mechanical pulverization.

In some examples, the first step further includes purifying after the spheroidizing. Preferably, the purifying is implemented by acid purification treatment.

In some examples, the carbon material resulting from the first step is spherical natural graphite with Dv50 being 5 μm to 25 μm; and preferably, the carbon material resulting from the first step is spherical natural graphite with Dv50 being 9 μm to 18 μm.

In some examples, in the second step, preferably, the pore regulation treatment includes any one or combination of at least two of modifier addition, fusion heating, cold isostatic pressing treatment, or mold pressing treatment. For example, the pore regulation treatment includes a combination of first cold isostatic pressing treatment and then modifier addition, which can reduce an overall pore volume and densify the material; or a combination of first modifier addition and then heat treatment, which can reserve a certain amount of mesopores in the material to facilitate transport of lithium ions and improve the fast charge performance of the material. A combination of first mold pressing treatment and then modifier addition can also achieve the technical effects described above.

In some examples, in the second step, the pore regulation treatment includes a combination of first cold isostatic pressing treatment and then modifier addition. Specifically, the carbon material obtained in the first step is placed into a cold isostatic press with a working pressure of 60 MPa to 70 MPa for processing. The pressure curve is specifically set to: increase from 0 MPa to a range of 20 MPa to 30 MPa within 8 min to 12 min and hold for 5 min to 10 min and then increase to a range of 60 MPa to 70 MPa within 25 min to 45 min and hold for 5 min to 8 min, to obtain blocky graphite. Then, the blocky graphite is pulverized to obtain graphite with Dv50 being 9 μm to 16 m and mixed with a modifier at a mass ratio of 100:5 to 100:20.

In some examples, in the second step, the pore regulation treatment includes a combination of first mold pressing treatment and then modifier addition. Specifically, the carbon material obtained in the first step is placed into a die press with a working pressure of 20 MPa to 25 MPa for processing. The pressure curve is specifically set to: increase from 0 MPa to a range of 10 MPa to 15 MPa within 8 min to 12 min and hold for 4 min to 5 min and then increase to a range of 20 MPa to 25 MPa within 15 min to 20 min and hold for 10 min to 15 min, to obtain blocky graphite. Then, the blocky graphite is pulverized to obtain graphite with Dv50 being 5 μm to 20 m and mixed with a modifier at a mass ratio of 100:5 to 100:20.

In some examples, in the second step, the pore regulation treatment includes a combination of first modifier addition and then fusion heating. Specifically, the carbon material obtained in the first step is mixed with a modifier at a mass ratio of 100:5 to 100:20. Then, the mixture is placed into a fusion machine, heated to 180° C. to 220° C. at a heating rate of 3° C./min to 7° C./min and a rotation speed of 1800 r/min to 2200 r/min, held for 1.5 h to 2.5 h, and then cooled to room temperature.

In some examples, in the second step, the pore regulation treatment includes modifier addition. The modifier is selected from any one or combination of at least two of resin, coal pitch, petroleum pitch, mesophase pitch, coal tar or heavy oil, glucose, sucrose, starch, polydopamine, polyvinyl alcohol, polypyrrole, polyethylene glycol, anthracene, aniline, citric acid, acetic acid or tannic acid. Preferably, the modifier is selected from any one or combination of at least two of resin, coal pitch, petroleum pitch, or mesophase pitch. Preferably, the modifier is added in an amount of 5 wt % to 20 wt % based on a weight of the carbon material.

In some examples, in the third step, the high-temperature heat treatment is performed at a temperature of 600° C. to 3000° C. Illustratively, the high-temperature heat treatment may be performed at a temperature of 800° C., 1000° C., 1200° C., 1500° C., 1800° C., 2100° C., 2300° C., 2500° C., 2800° C., or any value within a range limited by any two of the above values.

In some examples, specifically, in the third step, a temperature profile of the high-temperature heat treatment may be: heating to 200° C. at a heating rate of 3° C./min to 7° C./min, and keeping the temperature at 200° C. for 25 min to 35 min, heating to 600° C. at a heating rate of 1.5° C./min to 2.5° C./min, and keeping the temperature at 600° C. for 25 min to 35 min, and heating to 1000° C. to 1200° C. at a heating rate of 8° C./min to 12° C./min, and keeping the temperature at 1000° C. to 1200° C. for 180 min to 220 min.

In some examples, specifically, in the third step, a temperature profile of the high-temperature heat treatment may be: heating to 1200° C. at a heating rate of 8° C./min to 12° C./min, and keeping the temperature at 1200° C. for 25 min to 35 min, heating to 1800° C. at a heating rate of 8° C./min to 12° C./min, and heating to 2300° C. to 2800° C. at a heating rate of 15° C./min to 25° C./min, and keeping the temperature at 2300° C. to 2800° C. for 50 min to 70 min.

In some examples, in the third step, the high-temperature heat treatment is performed in an atmosphere of inert gas. Preferably, the inert gas is any one or combination of at least two of helium, neon, argon, nitrogen or krypton. The atmosphere protection of inert gas is beneficial to the preparation process of the material.

According to another aspect of the present application, there is provided a lithium-ion battery, including the anode material described above, or an anode material prepared in the preparation method described above. The lithium-ion battery has reduced expansibility as well as good cycle life and fast charge performance.

### SPECIFIC EXAMPLES AND COMPARATIVE EXAMPLES

### Example 1

First step S1: natural flake graphite is selected to be subjected to mechanical pulverization, spheroidization and acid purification treatment to obtain high-purity spherical natural graphite with a volume median particle size Dv50 of 9 μm.

Second step S2: the high-purity spherical natural graphite is placed into a cold isostatic press for processing, where a working pressure of the isostatic press is set to: increase from 0 MPa to 30 MPa in 10 min, hold at 30 MPa for 5 min, and increase to 60 MPa in 25 min, and hold for 8 min, to obtain blocky graphite. The blocky graphite is crushed and pulverized to obtain graphite with a volume median particle size Dv50 of 9 μm. The obtained graphite is mixed with pitch at a mass ratio of 100:10.

Third step S3: then the mixture is processed at a high temperature of 1200° C. in a nitrogen atmosphere to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1200° C. at a heating rate of 10° C./min, and keeping the temperature at 1200° C. for 200 min.

### Example 2

First step S1: natural flake graphite is selected to be subjected to mechanical pulverization, spheroidization and acid purification treatment to obtain high-purity spherical natural graphite with a volume median particle size Dv50 of 18 μm.

Second step S2: the high-purity spherical natural graphite is placed into a die press for processing, where a working pressure is set to: increase from 0 MPa to 10 MPa in 10 min, hold at 10 MPa for 5 min, and increase to 20 MPa in 15 min, and hold for 10 min, to obtain blocky graphite. The blocky graphite is crushed and pulverized to obtain graphite with a volume median particle size Dv50 of 18 μm. The obtained graphite is mixed with pitch at a mass ratio of 100:5.

Third step S3: then the mixture is processed at a high temperature of 1000° C. in a nitrogen atmosphere to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1000° C. at a heating rate of 10° C./min, and keeping the temperature at 1000° C. for 200 min.

### Example 3

First step S1: natural flake graphite is selected to be subjected to mechanical pulverization, spheroidization and treatment to obtain high-purity spherical natural graphite with a volume median particle size Dv50 of 17 μm.

Second step S2: The obtained graphite is mixed with pitch at a mass ratio of 100:6, and the mixture is placed into a fusion machine, heated to 200° C. at 5° C./min with a rotation speed of 2000 r/min, kept for 2 h, and then cooled to room temperature.

Third step S3: then the mixture is processed at a high temperature of 1200° C. to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1200° C. at a heating rate of 10° C./min, and keeping the temperature at 1200° C. for 200 min.

### Example 4

First step S1: microcrystalline graphite is selected to be subjected to mechanical pulverization, spheroidization and treatment to obtain high-purity spherical natural graphite with a volume median particle size Dv50 of 10 μm.

Second step S2: the high-purity spherical natural graphite is placed into a cold isostatic press for processing, where a working pressure of the isostatic press is set to: increase from 0 MPa to 20 MPa in 10 min, hold at 20 MPa for 5 min, and increase to 50 MPa in 20 min, and hold for 10 min, increase to 80 MPa in 10 min, and hold for 5 min, increase to 120 MPa in 15 min, and hold for 5 min, and increase to 150 MPa in 10 min, and hold for 1 min, to obtain blocky graphite. The blocky graphite is crushed and pulverized to obtain graphite with a volume median particle size Dv50 of 10 μm. The obtained graphite is mixed with pitch at a mass ratio of 100:20.

Third step S3: then the mixture is processed at a high temperature of 2800° C. to obtain a carbon material, where the specific temperature profile of the high-temperature treatment is: heating to 1200° C. at a heating rate of 10° C./min, and keeping the temperature at 1200° C. for 30 min, heating to 1800° C. at a heating rate of 10° C./min, and heating to 2800° C. at a heating rate of 20° C./min, and keeping the temperature for 60 min.

### Example 5

First step S1: natural flake graphite is selected to be subjected to mechanical pulverization, spheroidization and acid purification treatment to obtain high-purity spherical natural graphite with a volume median particle size Dv50 of 16 μm.

Second step S2: the high-purity spherical natural graphite is placed into a cold isostatic press for processing, where a working pressure of the isostatic press is set to: increase from 0 MPa to 30 MPa in 10 min, hold at 30 MPa for 5 min, and increase to 70 MPa in 45 min, and hold for 5 min, to obtain blocky graphite. The blocky graphite is crushed and pulverized to obtain graphite with a volume median particle size Dv50 of 16 μm. The obtained graphite is mixed with phenolic aldehyde resin at a mass ratio of 100:8.

Third step S3: then the mixture is processed at a high temperature of 2300° C. to obtain a carbon material, where the specific temperature profile of the high-temperature treatment is: heating to 1200° C. at a heating rate of 10° C./min, and keeping the temperature at 1200° C. for 30 min, heating to 1800° C. at a heating rate of 10° C./min, and heating to 2300° C. at a heating rate of 20° C./min, and keeping the temperature for 60 min.

### Example 6

First step S1: natural flake graphite is selected to be subjected to mechanical pulverization, spheroidization and acid purification treatment to obtain high-purity spherical natural graphite with a volume median particle size Dv50 of 10 m and Dv90/Dv10=2.0.

Second step S2: the high-purity spherical natural graphite is placed into a cold isostatic press for processing, where a working pressure of the isostatic press is set to: increase from 0 MPa to 50 MPa in 30 min, and hold for 10 min, increase to 150 MPa in 30 min, and hold for 5 min, and increase to 200 MPa in 25 min, and hold for 1 min, to obtain blocky graphite. The blocky graphite is crushed and pulverized to obtain graphite with a volume median particle size Dv50 of 10 m and Dv90/Dv10=2.0. The obtained graphite is mixed with pitch at a mass ratio of 100:15.

Third step S3: then the mixture is processed at a high temperature of 1200° C. to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1200° C. at a heating rate of 10° C./min, and keeping the temperature at 1200° C. for 200 min.

### Comparative Example 1

First step S1: natural flake graphite is selected to be subjected to mechanical pulverization, spheroidization and acid purification treatment to obtain high-purity spherical natural graphite with a volume median particle size Dv50 of 9 μm.

Compared with the examples, the second step S2 is simplified: the high-purity spherical natural graphite is mixed with the pitch at a mass ratio of 100:10.

Third step S3: then the mixture is processed at a high temperature of 1200° C. in a nitrogen atmosphere to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, keeping the temperature at 600° C. for 30 min, and heating to 1200° C. at a heating rate of 10° C./min, and keeping the temperature at 1200° C. for 200 min.

### Comparative Example 2

First step S1: natural flake graphite is selected to be subjected to mechanical pulverization, spheroidization and acid purification treatment to obtain high-purity spherical natural graphite with a volume median particle size Dv50 of 18 μm.

The second step S2 is omitted, and the third step S3 is directly performed: the high-purity spherical natural graphite is processed at a high temperature of 1000° C. in a nitrogen atmosphere to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1000° C. at a heating rate of 10° C./min, and keeping the temperature at 1000° C. for 200 min.

### Comparative Example 3

First step S1: natural flake graphite is selected to be subjected to mechanical pulverization, spheroidization and acid purification treatment to obtain high-purity spherical natural graphite with a volume median particle size Dv50 of 18 μm.

Compared with the examples, the second step S2 is simplified: the high-purity spherical natural graphite is mixed with the pitch at a mass ratio of 100:15.

Third step S3: then the mixture is processed at a high temperature of 1200° C. in a nitrogen atmosphere and depolymerized (which refers to a process of using a mechanical device to separate graphite particles bonded together due to viscidity of the pitch after the natural graphite is mixed and carbonized with pitch) to obtain a carbon material, and the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1200° C. at a heating rate of 10° C./min, and keeping the temperature at 1200° C. for 200 min.

### Comparative Example 4

First step S1: natural flake graphite is selected to be subjected to mechanical pulverization, spheroidization and acid purification treatment to obtain high-purity spherical natural graphite with a volume median particle size Dv50 of 18 μm.

Second step S2: the high-purity spherical natural graphite is mixed with the pitch at a mass ratio of 100:6, and then the mixture is placed into a cold isostatic press for processing, where a working pressure of the isostatic press is set to: increase from 0 MPa to 30 MPa in 10 min, hold at 30 MPa for 5 min, and increase to 60 MPa in 25 min, and hold for 8 min, to obtain blocky graphite.

Third step S3: processing is performed at a high temperature of 1200° C. in a nitrogen atmosphere to obtain a carbon material, where the specific temperature profile of the high-temperature treatment is: heating to 200° C. at a heating rate of 5° C./min, and keeping the temperature at 200° C. for 30 min, heating to 600° C. at a heating rate of 2° C./min, and keeping the temperature at 600° C. for 30 min, and heating to 1200° C. at a heating rate of 10° C./min, and keeping the temperature at 1200° C. for 200 min. The blocky graphite is crushed and pulverized to obtain graphite with a volume median particle size Dv50 of 18 μm.

The test method adopted in the present application includes: The volume median particle size Dv50 of the material is tested with a Malvern Malvern Master Size 3000 laser particle size analyzer: take approximately 0.1 g of sample, add 1 mL˜2 mL of ethanol, 20 mL˜30 mL of tertiary water, and then add a surfactant; then stir the mixture with a glass rod until the sample is completely dispersed, and then inject the entire mixture for analysis.

The specific surface area is tested with a Tristar device from Micromeritics: nitrogen gas is adopted for the test, with a degassing temperature of 300° C. and a degassing time of 1 hour; set P/Pₒ=0-0.3, arrange 5-7 measurement points, the minimum equilibrium degree under the P/Pₒ condition is ≥0.995, and the time is 600 seconds.

The pore volume is tested with a mercury porosimeter Micromeritics AutoPore IV 9500, to determine a pore volume in the range of 3 nm to 1,000 nm, a pore volume in the range of 3 nm to 400 nm, a pore volume in the range of 3 nm to 500 nm, and the like. Test Method: Set the pressure in the range of 0.001 MPa to 600.0 MPa, with at least 15 measurement points per order of magnitude. Continue the test until mercury fills all pores, then stop the test.

XRD test is performed with an X-ray diffractometer to select and obtain an intensity ratio of an 004 peak (2θ=54.6°) to a 110 peak (2θ=77.4°) to obtain a value of powder orientation (I₀₀₄/I₁₁₀).

The testing device and the high-precision Landi electric system (5V/100 mA) disclosed in patent application CN201920973729.5 are used to test the electrode sheet expansion rate after 20 cycles.

Conditions for Electrode Sheet Preparation and Test Conditions: Mix the provided anode material, conductive agent SP, CMC, and SBR at a mass ratio of 95.9:1.0:1.5:2.0 and then coat the mixture on a copper foil to obtain an anode sheet. The anode sheet has an areal density of 7 mg/cm², a compaction density of 1.6±0.03 g/cc, and a diameter of 16 mm. Mix the cathode active material NCM523, conductive agent SP, conductive agent SP, and PVDF thoroughly at a mass ratio of 97.5:1.0:0.5:1.5, and then coat the mixture on an aluminum foil to obtain a cathode sheet. The cathode sheet has an areal density of 16.6 mg/cm², a compaction density of 3.8 g/cc, and a diameter of 16 mm; the N/P ratio is 1.03˜1.05. The electrolyte is 1 mol/L LiPF₆+EC+DMC+EMC, with additives VC/FEC (1%˜3%).

### Charge and Discharge Step:

Rest 12 h;
1st cycle
Charge 0.01C-CC 30 min, 0.05C-CC30 min, 0.1C-CC, 4.2V-CV, 0.01C-cut, rest 5 min;
Discharge 0.1C-CC, 3.0V-cut, rest 5 min;
2nd cycle:
Charge 0.2C-CC, 4.2V-CV, 0.01C-cut, rest 5 min;
Discharge 0.2C-CC, 3.0V-cut, rest 5 min;
3rd˜20th cycle: Charge 0.5C-CC, 4.2V-CV, 0.01C-cut, rest 5 min;
Discharge 0.5C-CC, 3.0V-cut, rest 5 min

The thickness is measured using a Keyence sensor (model: GT2-71N). The calculation formula for expansion rate is: Expansion rate=(Thickness variation/Initial active layer thickness of the anode sheet)×100%.

An automatic compaction densitometer is used to test the compaction density of the material at a pressure of 1.0 T.

A Quantachrome Auto Tap instrument is used to test the tap density of the material by sampling 100 mL and vibrating for 1000 times at a vibration frequency of 260 times/min.

The fixed carbon content is tested by referring to GB/T3521-2008 “Methods for Chemical Analysis of Graphite”.

Test of battery: the provided carbon material, a conductive agent SP, CMC and SBR are mixed at a mass ratio of 95.9:1.0:1.3:1.8, and coated on a copper foil to obtain an anode sheet; a cathode active substance NCM523, a conductive agent SP, a conductive agent CNT and PVDF are mixed well at a mass ratio of 97.0:1.0:0.5:1.5, and coated on an aluminum foil to obtain a cathode sheet; the electrolyte solution is 1 mol/L of LiPF₆+EC+EMC, and the separator is a three-layer separator of PP/PE/PP. A pouch battery of about 38 mAh is manufactured and used for testing full battery performance of the material. The method for testing the capacity retention at 1C/1C includes: performing 300 continuous charge-discharge cycles at 1C rate.

Tables 1-1 and 1-2 show test results of the respective examples and comparative examples.

TABLE 1-1

| | | | Compacted | Tap | Fixed | | Pore |
|---|---|---|---|---|---|---|---|
| | Dv50 | BET | Density | Density | Carbon | | Volume V1 |
| | (μm) | (m²/g) | (g/cc) | (g/cc) | Content (%) | I₀₀₄/I₁₁₀ | (mL/g) |
| Example 1 | 9 | 2.1 | 1.56 | 0.98 | 99.94 | 2.3 | 0.084 |
| Example 2 | 18 | 2.3 | 1.75 | 1.05 | 99.95 | 2.9 | 0.079 |
| Example 3 | 17 | 2.5 | 1.71 | 1.03 | 99.97 | 2.7 | 0.074 |
| Example 4 | 10 | 1.8 | 1.97 | 1.09 | 99.94 | 2.2 | 0.080 |
| Example 5 | 16 | 2.9 | 1.88 | 1.08 | 99.96 | 2.7 | 0.086 |
| Example 6 | 10 | 1.7 | 1.68 | 1.15 | 99.95 | 1.6 | 0.078 |
| Comparative | 9 | 2.4 | 1.47 | 0.91 | 99.94 | 3.8 | 0.110 |
| example 1 | | | | | | | |
| Comparative | 18 | 4.6 | 1.99 | 0.95 | 99.95 | 3.0 | 0.138 |
| example 2 | | | | | | | |
| Comparative | 18 | 1.3 | 1.68 | 1.07 | 99.96 | 2.9 | 0.065 |
| example 3 | | | | | | | |
| Comparative | 18 | 3.1 | 1.79 | 1.05 | 99.95 | 2.5 | 0.042 |
| example 4 | | | | | | | |

TABLE 1-2

| | | | | | Electrode | |
|---|---|---|---|---|---|---|
| | Pore | Pore | | | sheet expansion | Retention |
| | Volume | Volume | | | rate after | rate after |
| | V2 (mL/g) | V3 (mL/g) | V2/V1 | V3/V1 | 20 cycles | 300 cycles |
| Example 1 | 0.051 | 0.059 | 59.5% | 70.2% | 24.8% | 91.2% |
| Example 2 | 0.032 | 0.048 | 40.5% | 60.8% | 26.1% | 88.4% |
| Example 3 | 0.039 | 0.051 | 52.7% | 68.9% | 24.1% | 91.8% |
| Example 4 | 0.055 | 0.060 | 68.8% | 75.0% | 23.8% | 92.1% |
| Example 5 | 0.040 | 0.051 | 46.5% | 61.6% | 26.2% | 87.9% |
| Example 6 | 0.051 | 0.061 | 65.4% | 78.2% | 22.3% | 93.3% |
| Comparative | 0.041 | 0.046 | 37.3% | 41.8% | 30.7% | 80.1% |
| example 1 | | | | | | |
| Comparative | 0.079 | 0.083 | 57.2% | 60.1% | 32.1% | 75.5% |
| example 2 | | | | | | |
| Comparative | 0.017 | 0.029 | 26.2% | 44.6% | 29.5% | 81.3% |
| example 3 | | | | | | |
| Comparative | 0.033 | 0.035 | 78.6% | 83.3% | 28.3% | 82.9% |
| example 4 | | | | | | |

It can be seen from the results in the table that the carbon material prepared in the method herein can reduce V1 to be less than 0.1 mL/g, the ratio V2/V1 ranges from 40% to 70%, and the ratio V3/V1≥60%. The carbon material such formed has an overall lower pore volume, where the pore sizes of pores are more concentrated in the range of 3 nm to 500 nm, while a proper amount of pores with moderate pore sizes of 400 nm to 500 nm, and a proper amount of pores with larger pore sizes of 500 nm to 1,000 nm, are also present, so that the rapid transport of lithium ions and more stable structure of the material are ensured. The electrode sheet expansion of the material after 20 cycles in the battery is obviously reduced to less than 27% and may be as low as 23.8%. The capacity retention rate after 300 cycles is increased by more than 5%, which effectively reduces expansion of the anode material in the cycle process and extends the long cycle life of battery, while enabling a lower impedance of the material and effectively improving the fast charge performance of the anode material.

It can be seen from the results of comparative examples 1 and 2 and examples 1 and 2 that since V1>0.1 mL/g in comparative examples 1 and 2, the contact between the material and the electrolyte solution increases and more electrolyte solution is consumed, resulting in a smaller amount of electrolyte solution and a thicker SEI film, and even V2/V1 is 40% to 70% and V3/V1>60%, the cycle life of the material will be significantly reduced, and the expansion rate of the electrode sheet will be increased.

It can be seen from the results of comparative example 3 (V2/V1<40%, and V3/V1<60%) that when it satisfies only V1<0.1 mL/g, but not V2/V1 ranges from 40% to 70% and V3/V1≥60% at the same time, internal pores of the material are excessively concentrated in the range of 500 nm to 1,000 nm despite the overall lower pore volume of the carbon material, and the too large pore sizes may cause reduced mechanical stability of the electrode material while increasing the contact and consumption of the electrolyte solution, also resulting in a significantly reduced cycle life of the material and an increased expansion rate of the electrode sheet, thereby affecting the cycle life and safety of the battery.

It can be seen from the results of comparative example 4 (V2/V1>70%) that when it satisfies only V1<0.1 mL/g and V3/V1≥60%, but not V2/V1 ranges from 40% to 70% at the same time, there will be a too small amount of internal pores of the material with pore sizes of 500 nm to 1,000 nm, and the pores are excessively concentrated in the range of 3 nm to 400 nm. The too small pore sizes are not beneficial to rapid transport of lithium ions and cause high impedance of the material, which may accelerate temperature rise of the battery as well as decomposition and consumption of the electrolyte solution, resulting in a higher expansion rate of the electrode sheet in the material, and a reduced cycle retention rate after 300 cycles.

The above experimental data shows that when a carbon material having the features defined in the present application is used as an anode of a lithium-ion battery, the electrode sheet expansion of the battery can be effectively reduced while the cycle life of the battery is improved.

Although various embodiments of the present application have been shown and described herein, it will be obvious to those skilled in the art that such embodiments are provided by way of example only. Numerous modifications, changes, and substitutions may occur to those skilled in the art without departing from the spirit and scope of the present application. It should be understood that various alternatives to the embodiments of the present application described herein may be employed while practicing the present application. It is intended that the following claims define the scope of the present application and that equivalents or alternatives within the scope of these claims are covered thereby.

1: An anode material comprising:
a carbon material having pores therein,
wherein a total pore volume of pores with a pore size of 3 nm or more and 1,000 nm or less, measured by mercury intrusion porosimetry is V1, and V1<0.1 mL/g;
a total pore volume of pores with a pore size of 3 nm or more and 400 nm or less, measured by mercury intrusion porosimetry is V2, and a ratio V2/V1 ranges from 40% to 70%; and
a total pore volume of pores with a pore size of 3 nm or more and 500 nm or less, measured by mercury intrusion porosimetry is V3, and a ratio V3/V1≥60%;
wherein, in an XRD spectrum of the anode material, an 004 peak is present at a diffraction peak angle 2θ of 54° to 55°, and the 004 peak has an intensity I₀₀₄,
a 110 peak is present at a diffraction peak angle 2θ of 77° to 78°, and the 110 peak has an intensity I₁₁₀, and
$${I}_{004} / {I}_{110} \leq 3. .$$

2. (canceled)

3. (canceled)

4. (canceled)

5. (canceled)

6: The anode material of claim 1, wherein the anode material has at least one of the following features:
a. a Brunauer-Emmett-Teller (BET) specific surface area ≤3.0 m²/g;
b. a volume median particle size (Dv50) in a range of 5 μm to 25 μm;
c. a compaction density in a range of 1.5 g/cc to 2.1 g/cc:
d. a tap density in a range of 0.9 g/cc to 1.2 g/cc: or
e. a fixed carbon content of the anode material is equal to or greater than 99.94%.

7. (canceled)

8. (canceled)

9: The anode material of claim 1, wherein the carbon material includes natural graphite.

10: A lithium-ion battery comprising the anode material of claim 1.

11: A preparation method for an anode material, the method comprising:
a first step of selecting a carbonaceous material feedstock, and pulverizing and spheroidizing the carbonaceous material feedstock;
a second step of performing pore regulation treatment on the carbon material obtained in the first step; and
a third step of subjecting the carbon material obtained in the second step to high-temperature heat treatment,
wherein the pore regulation treatment includes first cold isostatic pressing treatment or mold pressing treatment, and then modifier addition; wherein the pressure curve of the cold isostatic pressing treatment is set to: increase the pressure from 0 MPa to a range of 20 MPa to 30 MPa within 8 min to 12 min and hold for 5 min to 10 min, and then increase the pressure from a range of 20 MPa to 30 MPa to a range of 60 MPa to 70 MPa within 25 min to 45 min and hold for 5 min to 8 min; or the pressure curve of the mold pressing treatment is set to: increase the pressure from 0 MPa to a range of 10 MPa to 15 MPa within 8 min to 12 min and hold for 4 min to 5 min, and then increase the pressure from a range of 10 MPa to 15 MPa to a range of 20 MPa to 25 MPa within 15 min to 20 min and hold for 10 min to 15 min;
a temperature profile of the high-temperature heat treatment is as follows: heating to 200° C. at a heating rate of 3° C./min to 7° C./min, and keeping the temperature at 200° C. for 25 min to 35 min, heating from 200° C. to 600° C. at a heating rate of 1.5° C./min to 2.5° C./min, and keeping the temperature at 600° C. for 25 min to 35 min, and heating from 600° C. to a range of 1000° C. to 1200° C. at a heating rate of 8° C./min to 12° C./min, and keeping the temperature at 1000° C. to 1200° C. for 180 min to 220 min.

12: The preparation method of claim 11, wherein, in the first step, the carbonaceous material feedstock is selected from the group consisting of one or more of natural spherical graphite, natural flake graphite, or microcrystalline graphite.

13: The preparation method of claim 11, wherein the first step further includes purifying after the spheroidizing.

14: The preparation method of claim 12, wherein the first step further includes purifying after the spheroidizing.

15: The preparation method of claim 11, wherein in the second step, the pore regulation treatment includes adding a modifier selected from the group consisting of any one or combination of at least two of resin, coal pitch, petroleum pitch, mesophase pitch, coal tar, sucrose, starch, polydopamine, polyvinyl alcohol, polypyrrole, polyethylene glycol, anthracene, aniline, citric acid, acetic acid or tannic acid.

16: The preparation method of claim 12, wherein, in the second step, the pore regulation treatment includes adding a modifier selected from the group consisting of any one or combination of at least two of resin, coal pitch, petroleum pitch, mesophase pitch, coal tar, sucrose, starch, polydopamine, polyvinyl alcohol, polypyrrole, polyethylene glycol, anthracene, aniline, citric acid, acetic acid or tannic acid.

17: The preparation method of claim 11, wherein the third step includes at least one of the following features:
a. the high-temperature heat treatment is performed at a temperature of 600° C. to 3000° C.; or
b. the high-temperature heat treatment is performed in an atmosphere of inert gas, wherein the inert gas is any one or combination of at least two of helium, neon, argon, nitrogen or krypton.

18: The preparation method of claim 12, wherein the third step includes at least one of the following features:
a. the high-temperature heat treatment is performed at a temperature of 600° C. to 3000° C.; or
b. the high-temperature heat treatment is performed in an atmosphere of inert gas, wherein the inert gas is any one or combination of at least two of helium, neon, argon, nitrogen or krypton.

19: A lithium-ion battery comprising the anode material prepared in the preparation method of claim 11.
